(19) United States
(12) Patent Application Publication
(10) Pub. No.: US 2025/0279548 A1
(43) Pub. Date: Sep. 4, 2025

(54) BUSBAR MODULE INCLUDING CLAMPING AND GUIDING FEATURES

(71) Applicant: Ford Global Technologies, LLC, Dearborn, MI (US)

(72) Inventors: Guangchun Quan, Ann Arbor, MI (US); Folarin Davies, Detroit, MI (US)

(21) Appl. No.: 18/593,195

(22) Filed: Mar. 1, 2024

(51) Int. Cl. H01M 50/503; H01M 50/505; H01M 50/516

(52) U.S. Cl. CPC H01M 50/503; H01M 50/505; H01M 50/516; H01M 2220/20

(57) ABSTRACT

A battery pack may include a busbar including a slot. The battery pack may further include a battery cell including a housing and a tab terminal extending from the housing. The tab terminal may be received within the slot such that at least a portion of the tab terminal is positioned on an opposite side of the busbar from the housing. The battery pack may additionally include a busbar frame including a projection. The projection may be received within the slot such that at least a portion of the projection is positioned on the opposite side of the busbar from the housing.

### TECHNICAL FIELD

This disclosure relates generally to electrified vehicles, and more specifically relates to a busbar module including clamping and guiding features.

### BACKGROUND

A high voltage traction battery pack typically powers the electric machines and other electrical loads of an electrified vehicle. The traction battery pack includes a plurality of battery cells. The battery cells must be reliably connected to one another in order to provide the voltage and power levels necessary for achieving vehicle propulsion.

### SUMMARY

In some aspects, the techniques described herein relate to a battery pack, including: a busbar including a slot; a battery cell including a housing and a tab terminal extending from the housing, wherein the tab terminal is received within the slot such that at least a portion of the tab terminal is positioned on an opposite side of the busbar from the housing; and a busbar frame including a projection, wherein the projection is received within the slot such that at least a portion of the projection is positioned on the opposite side of the busbar from the housing.

In some aspects, the techniques described herein relate to a battery pack, wherein the tab terminal is in direct contact with a surface of a bent portion of the busbar.

In some aspects, the techniques described herein relate to a battery pack, wherein the bent portion establishes a base of the slot.

In some aspects, the techniques described herein relate to a battery pack, wherein the tab terminal is also in direct contact with the projection.

In some aspects, the techniques described herein relate to a battery pack, wherein a surface of the projection in direct contact with the tab terminal includes at least one rib.

In some aspects, the techniques described herein relate to a battery pack, wherein a surface of the projection opposite the surface in direct contact with the tab terminal includes a rounded profile.

In some aspects, the techniques described herein relate to a battery pack, wherein an end of the tab terminal projects further into the slot than the projection, such that the end of the tab terminal is spaced-apart further from the side of the busbar opposite the housing than an end of the projection.

In some aspects, the techniques described herein relate to a battery pack, wherein: the busbar frame includes a main section, the main section includes a slot, and the tab terminal projects through the slot of the busbar frame and through the slot of the busbar.

In some aspects, the techniques described herein relate to a battery pack, wherein the busbar frame further includes a first ramped surface on a first side of the slot and projecting toward the housing, and a second ramped surface on a second side of the slot and projecting toward the housing.

In some aspects, the techniques described herein relate to a battery pack, wherein the first and second ramped surfaces face toward one another.

In some aspects, the techniques described herein relate to a battery pack, wherein: the first and second ramped surfaces are provided by first and second projections, respectively, projecting toward the housing.

In some aspects, the techniques described herein relate to a battery pack, wherein the projection includes at least one finger projecting further from the side of the busbar opposite the housing than a remainder of the projection.

In some aspects, the techniques described herein relate to a battery pack, wherein the at least one finger includes a first side finger arranged adjacent a first side edge of the projection, and a second side finger arranged adjacent a second side edge of the projection opposite the first side.

In some aspects, the techniques described herein relate to a battery pack, wherein the at least one finger further includes a third finger arranged substantially between the first and second side fingers.

In some aspects, the techniques described herein relate to a battery pack, including a weld that secures the tab terminal to the bent portion.

In some aspects, the techniques described herein relate to a battery pack, wherein the busbar frame and the busbar establish a busbar module of the battery pack.

In some aspects, the techniques described herein relate to a method, including: electrically connecting a tab terminal of a battery cell to a busbar by inserting the tab terminal through a busbar frame and through a slot in the busbar, wherein the busbar frame includes a projection, wherein the projection is received within the slot such that at least a portion of the projection is positioned on an opposite side of the busbar from a housing of the battery cell.

In some aspects, the techniques described herein relate to a method, wherein the tab terminal is in direct contact with the projection and a bent portion of the busbar.

In some aspects, the techniques described herein relate to a method, wherein: the busbar frame includes a main section, the main section includes a slot, and the tab terminal projects through the slot of the busbar frame and through the slot of the busbar.

In some aspects, the techniques described herein relate to a method, wherein: the busbar frame further includes a first ramped surface on a first side of the slot and projecting toward the housing, and a second ramped surface on a second side of the slot and projecting toward the housing, and the first and second ramped surfaces guide the tab terminal as the tab terminal is inserted through the busbar frame.

### BRIEF DESCRIPTION OF THE DRAWINGS

FIG. 1 schematically illustrates an electrified vehicle.

FIG. 2 is a perspective view of a battery pack for an electrified vehicle.

FIG. 3 is a cross-sectional view of the battery pack of FIG. 2.

FIG. 4 illustrates a battery cell of a battery array of a battery pack.

FIG. 5 illustrates an example busbar module relative to a battery array.

FIG. 6 is a cross-sectional view through section 6-6 of FIG. 5.

FIG. 7 is a close-up, perspective view of the busbar module, in which a projection of a busbar frame has two fingers.

FIG. 8 is a close-up, perspective view of the busbar module, in which the projection of the busbar frame has three fingers.

FIG. 9 is a close-up, perspective view of the busbar module, in which the projection of the busbar frame is without fingers.

FIG. 10 is a cross-sectional view similar to FIG. 6 and illustrates an example configuration of the projection including a rib.

### DETAILED DESCRIPTION

This disclosure relates generally to electrified vehicles, and more specifically relates to a busbar module including clamping and guiding features. A corresponding method is also disclosed. The busbar module of this disclosure facilitates assembly of a battery pack by permitting one to readily align multiple tab terminals relative to a busbar. The busbar module of this disclosure further facilitates assembly of the battery pack by holding the tab terminals in place relative to a corresponding portion of the busbar. These and other benefits will be appreciated from the following description.

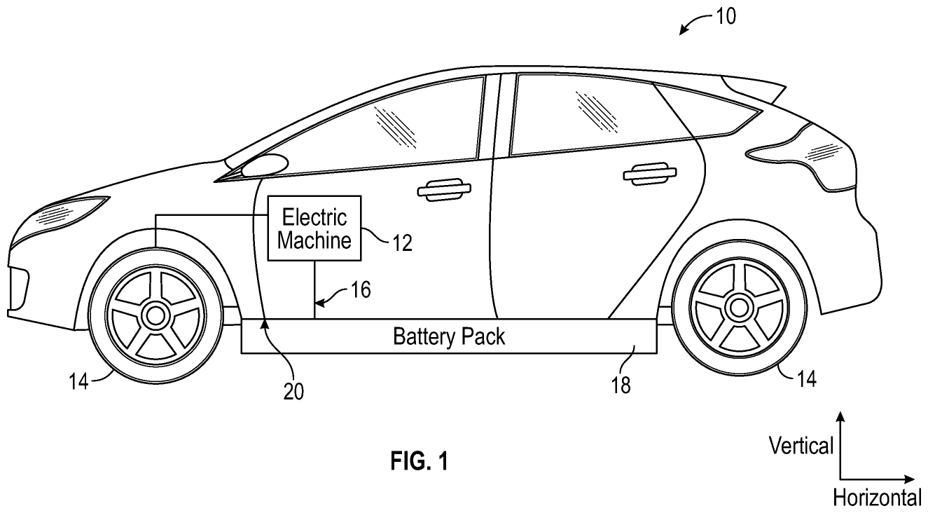

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

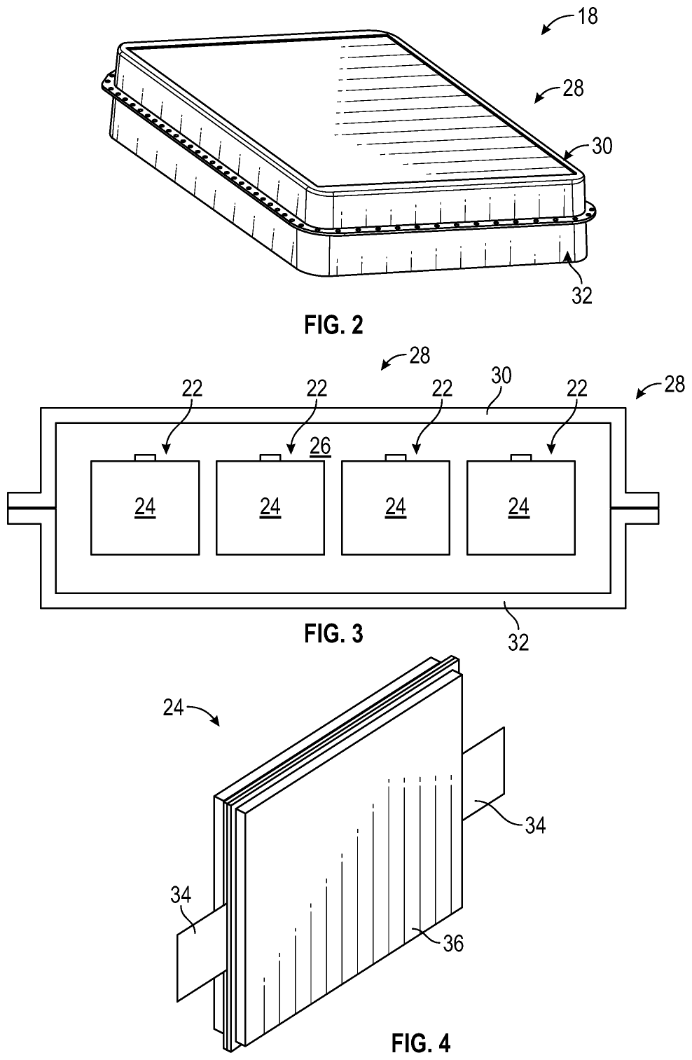

FIGS. 2 and 3 illustrate additional details associated with the traction battery pack 18 of the electrified vehicle 10. The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 24 may be stacked side-by-side along a stack axis to construct a grouping of battery cells 24, sometimes referred to as a “cell stack.” In the highly schematic depiction of FIG. 3, the battery cells 24 are stacked in a direction into the page to construct each battery array 22, and thus the battery arrays 22 may extend in cross-car direction. However, other configurations may also be possible. The total number of battery arrays 22 and battery cells 24 provided within the traction battery pack 18 is not intended to limit this disclosure.

In an embodiment, the battery cells 24 of each battery array 22 are pouch style, lithium-ion cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide the interior area 26. The size, shape, and overall configuration of the enclosure assembly 28 is not intended to limit this disclosure.

FIG. 4 illustrates one of the battery cells 24 that can be provided within the traction battery pack 18. Each battery cell 24 may include a housing 36 and a pair of tab terminals 34 that project outwardly from the housing 36. In an embodiment, each battery cell 24 includes two tab terminals 34, with one tab terminal 34 protruding outwardly at each opposing side of the housing 36. In some implementations, the housing 36 is a multi-layered structure including an aluminum film layer and a polymer layer. However, other housing configurations are also contemplated within the scope of this disclosure.

The tab terminals 34 of the battery cells 24 of each battery array 22 must be reliably connected to one another in order to provide the voltage and power levels necessary for achieving vehicle propulsion. Busbars are sometimes used for making such a connection, however, it can be difficult to properly position and align the tab terminals 34 relative to the busbar during assembly and welding processes. This disclosure is therefore specifically directed to busbars that include features for facilitating proper positioning and alignment of the tab terminals 34 when joining the tab terminals 34 to a busbar.

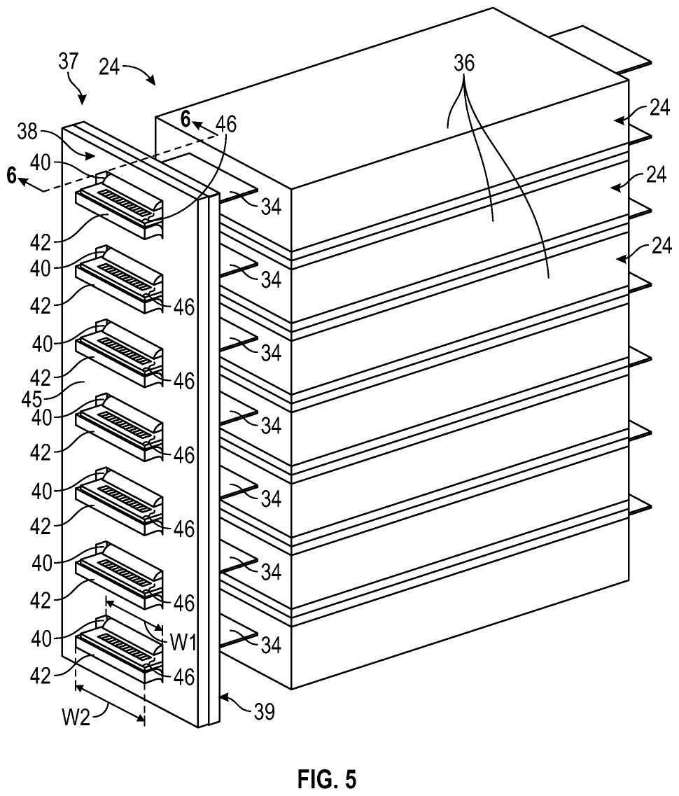

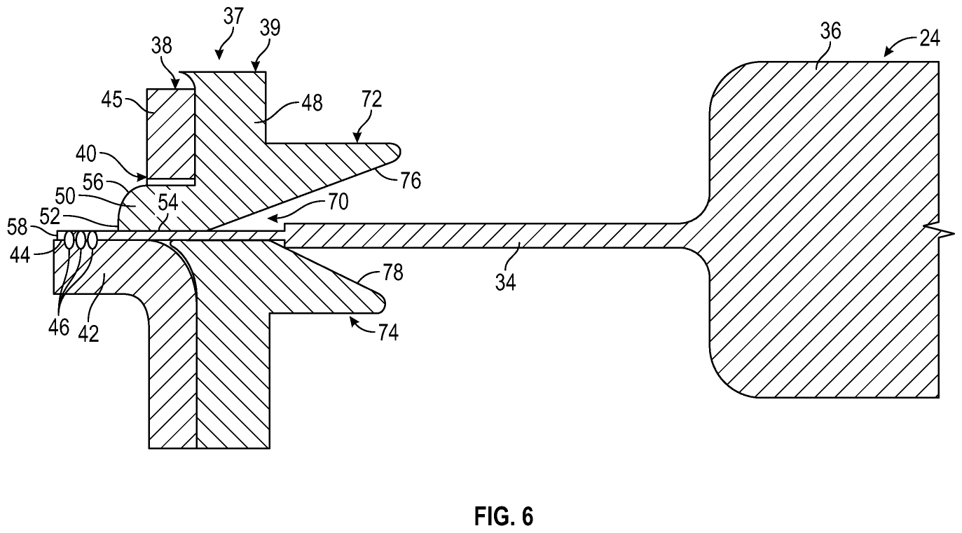

FIGS. 5 and 6 illustrate an example busbar module 37 according to this disclosure relative to a grouping of battery cells 24. The example busbar module 37 includes a busbar 38 and a busbar frame 39.

The busbar 38 may be joined to tab terminals 34 of a grouping of battery cells 24 for electrically connecting the battery cells 24. The grouping of battery cells 24 may be part of one of the battery arrays 22 of the traction battery pack 18, for example. Once electrically coupled, the battery cells 24 may supply electrical power for powering various components of the electrified vehicle 10. In the illustrated embodiment, the busbar 38 is configured to join the tab terminals 34 of seven adjacent battery cells 24. However, the busbar 38 could be configured to join a greater or fewer number of tab terminals 34/battery cells 24 within the scope of this disclosure.

The busbar 38 may include a plurality of slots 40. Each slot 40 may be formed through a main body 45 of the busbar 38 and may be sized for receiving one of the cell tab terminals 34. In an embodiment, each slot 40 includes a first width W1 that is larger than a second width W2 of the cell tab terminal 34 received therethrough. The cell tab terminals 34 may extend through the slots 40 such that at least a portion of each cell tab terminal 34 is located on an opposite side of the busbar 38 from the housing 36 of its respective battery cell 24.

The busbar 38 may additionally include a plurality of bent portions 42. One bent portion 42 may be provided adjacent each slot 40 of the busbar 38, and the bent portion 42 may establish a base of the slot 40, for example. The bent portions 42 are bent in a direction away from the battery cells 24, namely away from the housings 36 of the battery cells 24.

Each slot 40 may be formed in a punch or cutting process, and each bent portion 42 may be formed in a separate bending process. Alternatively, each slot 40 and bent portion 42 pair may be formed in a single step as part of a lance and form process.

The tab terminals 34 may be received against and supported by an upper surface 44 of the bent portions 42. Each upper surface 44 may provide a relatively flat surface for locating the tab terminal 34 relative to the respective slot 40 and bent portion 42.

The tab terminals 34 may be joined to the upper surface 44 of the bent portion 42 by one or more welds 46. The welds 46 may be linear or non-linear welds. Prior to formation of the welds 46, the tab terminals 34 may be clamped and/or spot welded to the bent portions 42 to aid in the joining process.

The busbar frame 39 is made of an electrically insulative material, in this example. The busbar frame 39 includes features configured to facilitate clamping of a tab terminal 34 relative to a respective bent portion 42, and to guide the tab terminals 34 relative to a respective slot 40.

One clamping assembly will now be described. With reference to FIG. 6, busbar frame 39 includes a main body 48 arranged on the same side of the busbar 38 as the housings 36 of the battery cells 24. The busbar frame 39 further includes a projection 50 extending through the slot 40 such that a portion, namely an end 52, of the projection 50 is on a side of the busbar opposite the housings 36.

The projection 50 is arranged such that the upper surface of the tab terminal 34 is in direct contact with a bottom surface 54 of the projection 50. The bottom surface 54 is substantially parallel to upper surface 44. In this way, the projection 50 is configured to clamp the tab terminal 34 to the bent portion 42. In this disclosure, the terms “upper” and “bottom” are used with reference to the orientation of the components in FIG. 6, for example, and are not otherwise limiting.

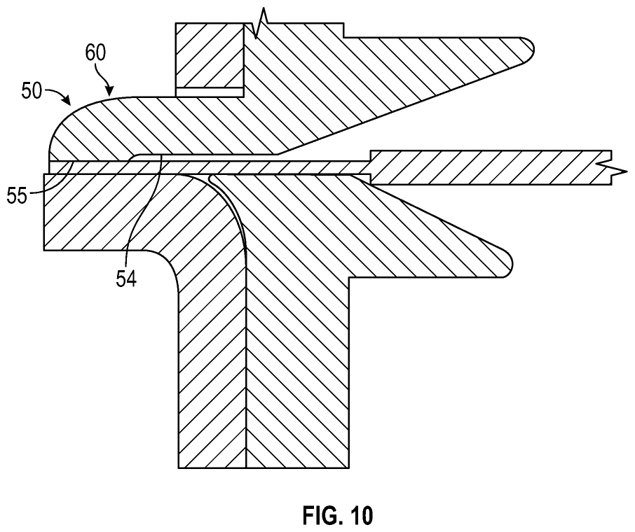

The bottom surface 54 of the projection 50 may include one or more raised surface features to facilitate engagement with the tab terminal 34, such as one or more ribs or ridges. An example rib 55 is shown in FIG. 10 projecting downward from the remainder of the bottom surface 54 of projection 50. In this example, the rib 55 is provided in the location of a first side finger 60 (explained below). The rib 55 could be in another location along the projection 50 and is not required to be on a finger. An upper surface 56 of the projection 50 adjacent the end 52 exhibits a rounded profile in this example to facilitate positioning the projection 50 into the slot 40.

In this disclosure, the end 58 of the tab terminal 34 is spaced-apart further from the main body 45 of the busbar 38 than the end 52. In this way, the projection 50 does not interfere with the formation of welds 46.

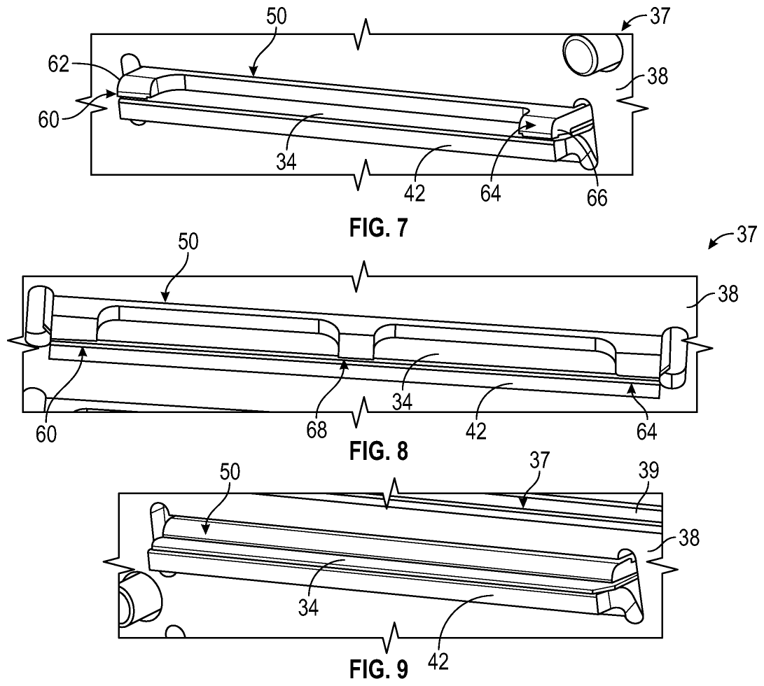

The projection 50 may include one or more fingers projecting further through the slot 40 than other portions of the projection 50, as shown in FIGS. 7 and 8. In FIG. 7, the projection 50 includes a first side finger 60 arranged adjacent a first side edge 62 of the projection 50, and a second side finger 64 arranged adjacent a second side edge 66 of the projection 50 opposite the first side. In FIG. 8, the projection includes a third finger 68 arranged substantially between the first and second side fingers 60, 64. When the projection 50 includes one or more fingers, the welds 46 may be provided adjacent, or between, those fingers. The fingers may be formed, in one example, by selectively cutting certain portions of the projection 50.

FIG. 9 illustrates an embodiment in which the projection 50 does not exhibit any fingers, and instead exhibits a constant profile along its length. While some example projections have been described, it should be understood that the busbar frame 39 includes a plurality of such projections, with one projection corresponding to each slot 40.

The busbar frame 39 further includes a plurality of slots 70 formed in the main body 48. The slots 70 are aligned with a corresponding slot 40 of the busbar 38. The busbar frame 39 includes a plurality of guiding features configured to facilitate guiding of the tab terminals relative to the slots 40, 70, with one arrangement of guiding features provided adjacent each of the slots 70. An example guiding feature will now be described.

The busbar frame 39 includes a first guide projection 72 and a second guide projection 74 projecting from main body 48 and toward the housing 36. The first and second guide projections 72, 74 are arranged adjacent the slot 70 and are provided on opposite sides of the slot 70. The first guide projection 72 includes a first ramped surface 76 facing toward the slot 70 and moving gradually away from the slot 70 as the first ramped surface 76 moves toward the housing 36. The first guide projection 74 includes a second ramped surface 78 facing toward the slot 70 and toward the first ramped surface 76. The second ramped surface 78 moves gradually away from the slot 70 as the second ramped surface 78 moves toward the housing 36. If the tab terminal 34 comes into contact with either of the first or second ramped surfaces 76, 78 during insertion of the tab terminal 34 into the slot 70, the first and second ramped surfaces 76, 78 naturally guide the tab terminal 34 back toward the slot 70.

The busbar 38 may be a metallic component of the busbar module 37, and the busbar frame 39 may be a plastic component of the busbar module 37. In an embodiment, the busbar 38 is made of copper or aluminum, and the busbar frame 39 is made of polypropylene or polyethylene. However, other materials are contemplated within the scope of this disclosure.

The embodiments described above and shown in FIGS. 5 and 6 provide a “lap joint” design between the busbar 38 and the tab terminals 34. However, other configurations are contemplated within the scope of this disclosure.

It should be understood that terms such as “about” and “substantially” are not intended to be boundaryless terms, and should be interpreted consistent with the way one skilled in the art would interpret those terms. Directional terms such as “above,” “upper,” “below,” “bottom,” etc., are used with reference to the arrangement of the corresponding components in the drawings and are not intended to otherwise be limiting.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A battery pack, comprising:
a busbar including a slot;
a battery cell including a housing and a tab terminal extending from the housing, wherein the tab terminal is received within the slot such that at least a portion of the tab terminal is positioned on an opposite side of the busbar from the housing; and
a busbar frame including a projection, wherein the projection is received within the slot such that at least a portion of the projection is positioned on the opposite side of the busbar from the housing.

2. The battery pack as recited in claim 1, wherein the tab terminal is in direct contact with a surface of a bent portion of the busbar.

3. The battery pack as recited in claim 2, wherein the bent portion establishes a base of the slot.

4. The battery pack as recited in claim 2, wherein the tab terminal is also in direct contact with the projection.

5. The battery pack as recited in claim 4, wherein a surface of the projection in direct contact with the tab terminal includes at least one rib.

6. The battery pack as recited in claim 4, wherein a surface of the projection opposite the surface in direct contact with the tab terminal includes a rounded profile.

7. The battery pack as recited in claim 2, wherein an end of the tab terminal projects further into the slot than the projection, such that the end of the tab terminal is spaced-apart further from the side of the busbar opposite the housing than an end of the projection.

8. The battery pack as recited in claim 1, wherein:
the busbar frame includes a main section,
the main section includes a slot, and
the tab terminal projects through the slot of the busbar frame and through the slot of the busbar.

9. The battery pack as recited in claim 8, wherein the busbar frame further includes a first ramped surface on a first side of the slot and projecting toward the housing, and a second ramped surface on a second side of the slot and projecting toward the housing.

10. The battery pack as recited in claim 9, wherein the first and second ramped surfaces face toward one another.

11. The battery pack as recited in claim 9, wherein:
the first and second ramped surfaces are provided by first and second projections, respectively, projecting toward the housing.

12. The battery pack as recited in claim 1, wherein the projection includes at least one finger projecting further from the side of the busbar opposite the housing than a remainder of the projection.

13. The battery pack as recited in claim 12, wherein the at least one finger includes a first side finger arranged adjacent a first side edge of the projection, and a second side finger arranged adjacent a second side edge of the projection opposite the first side.

14. The battery pack as recited in claim 13, wherein the at least one finger further includes a third finger arranged substantially between the first and second side fingers.

15. The battery pack as recited in claim 2, comprising a weld that secures the tab terminal to the bent portion.

16. The battery pack as recited in claim 1, wherein the busbar frame and the busbar establish a busbar module of the battery pack.

17. A method, comprising:
electrically connecting a tab terminal of a battery cell to a busbar by inserting the tab terminal through a busbar frame and through a slot in the busbar, wherein the busbar frame includes a projection, wherein the projection is received within the slot such that at least a portion of the projection is positioned on an opposite side of the busbar from a housing of the battery cell.

18. The method as recited in claim 17, wherein the tab terminal is in direct contact with the projection and a bent portion of the busbar.

19. The method as recited in claim 17, wherein:
the busbar frame includes a main section,
the main section includes a slot, and
the tab terminal projects through the slot of the busbar frame and through the slot of the busbar.

20. The method as recited in claim 19, wherein:
the busbar frame further includes a first ramped surface on a first side of the slot and projecting toward the housing, and a second ramped surface on a second side of the slot and projecting toward the housing, and
the first and second ramped surfaces guide the tab terminal as the tab terminal is inserted through the busbar frame.
